(19) United States
(12) Patent Application Publication
(10) Pub. No.: US 2021/0284515 A1
(43) Pub. Date: Sep. 16, 2021

(54) PAINT CAN TOOL

(71) Applicant: Timothy J. Nolan, Blue Bell, PA (US)

(72) Inventor: Timothy J. Nolan, Blue Bell, PA (US)

(21) Appl. No.: 16/815,109

(22) Filed: Mar. 11, 2020

(51) Int. Cl. B67B 7/14

(52) U.S. Cl. CPC B67B 7/14

(57) ABSTRACT

A tool for opening the lid of a paint can consists of an elongated, generally planar, metal plate with a handle portion and a widened end having a concave edge configuration with contact areas at opposite ends of the edge for engaging the lid of a paint can at two spaced locations. The concave edge is also formed with a bend that deviates from a plane in which the handle portion of the plate lies. The bend allows the end of the tool to be inserted into a recess surrounding the paint can lid despite the spacing of the two contact areas. The tool allows the paint can lid to be pried open by prying motions at a small number of circumferentially spaced locations, and avoids the concentration of force that results in lid deformation in the case of a conventional prying tool.

### FIELD OF THE INVENTION

This invention relates to tools for use in removal and replacement of paint can lids, and more particularly to a device for facilitating the opening of a paint can.

### BACKGROUND OF THE INVENTION

A typical conventional paint can is formed with a rim having a circular groove for frictionally receiving a circular structure having a U-shaped cross-section, formed at the perimeter of a lid. The can is opened by inserting a prying tool into an annular space between the perimeter of the lid and the upper edge of the side wall of the can, engaging the tip of the prying tool with a bead on the perimeter of the lid and, by using the upper edge of the side wall as a fulcrum, exerting an upward force on the bead by pressing downward on the end of the prying tool opposite from the tip.

To open a paint can, it is usually necessary to apply the prying force at several locations around the circumference of the lid, often as many as five or more locations. In addition, the force exerted by the tool has a tendency to form permanent bends in the lid of the paint can, impairing complete reclosure and allowing for leakage and evaporation of solvent.

Another problem encountered in the opening of a paint can is that the lid is grasped manually after it is pried open, and often accidentally dropped, causing paint to come into contact with floors, clothing, etc.

### SUMMARY OF THE INVENTION

An object of this invention is to provide an improved prying tool that requires only a minimal number of prying steps, and that avoids deformation of the paint can lid.

Briefly, the tool consists of an elongated, generally planar, metal plate with a handle portion and a widened end having a concave edge configuration with angled contact areas at opposite ends of the edge for engaging the lid of a paint can at two spaced locations. By engaging the tool with the lid at two spaced locations simultaneously, a prying force can be exerted without deforming the lid. The concave edge is also formed with a bend that deviates from a plane in which the handle portion of the plate lies. This bend allows the spaced, angled tips of the tool to be inserted into the part of the annular space surrounding the perimeter of the lid while allowing a part of the tool to engage the upper edge of the wall of the can, which serves as a fulcrum. The device allows the paint can lid to be pried open by prying motions at a small number of locations, e.g., three locations spaced 120° apart from one another about the perimeter of the lid, and avoids the concentration of force that results in lid deformation in the case of a conventional prying tool.

More specifically, the paint can tool according to the invention comprises an elongated metal plate having opposite proximal and distal ends. The plate includes a handle portion extending along a handle axis in a forward direction from the proximal end toward the distal end, to an intermediate location along the direction of elongation of the plate. The plate also includes a paint can lid removal portion at the distal end. The paint can lid removal portion has opposite side edges, and a concave edge facing in the forward direction. The concave edge extends from a location adjacent one of the opposite side edges to a location adjacent the other side edge and includes two paint can lid-engaging edge portions spaced from each other and respectively located adjacent the opposite side edges of the plate. These lid-engaging portions are tangent to a first imaginary circular cylinder having an axis of symmetry intersecting the handle axis perpendicularly. The portion of the concave edge between the spaced lid-engaging edge portions thereof is spaced outward from the first imaginary cylinder, and a portion of the elongated plate including the distal end thereof is curved so that said concave edge is also disposed substantially in the perimeter of a second imaginary circular cylinder having a diameter equal to that of the first imaginary cylinder and an axis of symmetry parallel to the handle axis.

Optionally, the tool includes a permanent magnet, secured to the plate at a location between the proximal and distal ends thereof, for lifting a paint can lid when the lid is removed from a paint can so that the lid can be inverted and placed on a supporting surface with a portion of the tool including the magnet located between the lid and the supporting surface.

The tool can also include a hammer head fastened to the plate at a location adjacent the proximal end for tapping the lid into place when the lid is returned to the paint can. The hammer head is preferably in the form of a metal stud covered by rubber or a similar elastomeric material to prevent the tapping action from damaging the paint can lid.

The tool is primarily intended for use with one gallon paint cans, the lids of which typically have a diameter of approximately six inches. Thus, in the case of a tool designed for a one gallon paint can, the diameter of the imaginary cylinders will also be approximately six inches. However the dimensions of the tool can be varied to accommodate paint cans of other sizes.

When designed for use with larger paint cans, e.g., one gallon cans, the tool can also be formed with one or more protrusions at the proximal end of the plate for use in removal of lids from smaller paint cans.

### BRIEF DESCRIPTION OF THE DRAWINGS

FIG. 1 is a top plan view of the paint can tool in accordance with the invention, including broken lines to illustrate the direction of elongation of the tool and the first imaginary circular cylinder to which the spaced, paint can lid-engaging, edge portions of the tool are in tangential relationship;

FIG. 2 is a right side elevational view of the tool;

FIG. 3 is a bottom plan view of the tool;

FIG. 4 is an elevational view of the tool as viewed toward the distal end thereof, including broken lines to illustrate the second imaginary cylinder defining the curvature of the concave edge of the distal end portion about an axis parallel to the direction of elongation of the tool;

FIG. 5 is an elevational view of the tool as viewed toward the proximal end thereof;

FIG. 6 is a perspective view showing a portion of a paint can and of the tool, and showing the tool in use; and

FIG. 7 is a cross-sectional view taken on a section plane indicated by the numbers 7-7 in FIG. 6.

### DETAILED DESCRIPTION OF THE PREFERRED EMBODIMENTS

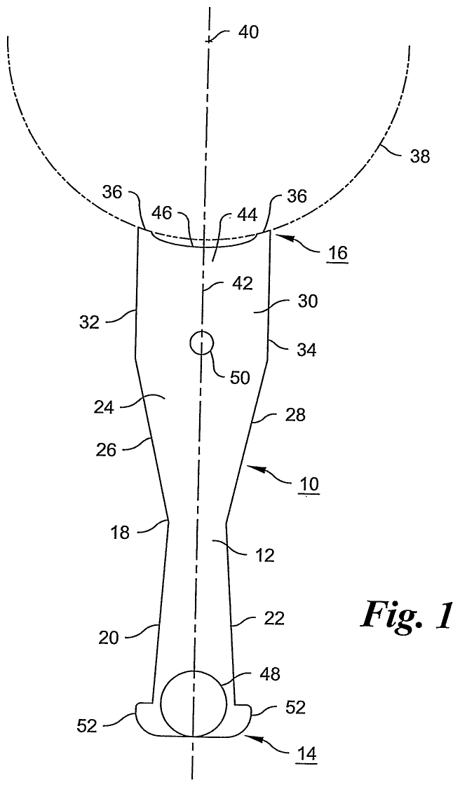

The tool 10, as shown in FIG. 1 comprises an elongated metal plate 12 having a proximal end 14 and a distal end 16. The plate is preferably composed of a high carbon steel, in the range from AISE/SAE grades 1050 to 1070, and typically has a thickness of about 0.055 inch. The part of the plate extending from the proximal end to an intermediate location 18 serves as a grip, and its side edges 20 and 22 converge slightly, from the proximal end 14 toward the intermediate location 18. The portion of the plate extending from the intermediate location 18 to the distal end 16 includes a portion 24 between edges 26 and 28, which diverge from the intermediate location 18 in the direction toward the distal end, and a distal portion 30 between parallel edges 32 and 34.

The distal end 16 is formed with two lid-engaging edges 36 spaced from each other. These lid engaging edges, which are preferably straight, or approximately straight, are disposed so that they can come into a tangential relationship with the cylindrical part of the perimeter of a paint can lid, represented in FIG. 1 by a broken line circle 38 having its center 40 on a center line 42 extending as a along the direction of elongation of the tool 10, the line being an axis of symmetry of the tool, located midway between edges 32 and 34, edges 26 and 28, and edges 20 and 22. If each of the lid-engaging edges 36 is disposed at an angle of 75° relative to center line 42, then, if the mid-points of the lid-engaging edges are tangent to circle 38, they will be spaced by a distance D, which is

D=2r sin(90°−75°)

where r is the radius of the circle. Thus, in the case of a lid having a diameter of six inches, the distance D will be approximately 1.55 inches.

The portion 44 of the distal end 16 of the tool between the lid-engaging edges 36 is recessed so that it does not interfere with the engagement of the lid by the two lid-engaging edges 36. But portion 44 is recessed only by an amount such that all, or at least a substantial part, of the bottom surface of the distal end portion of the tool is able to contact the bead at the upper edge of a paint can side wall while the lid-engaging edges are in contact with the lid, in order to allow for an effective prying action. Thus, the points of contact of the respective protrusions with the perimeter portion of the lid that are closest to each other, and a intermediate point on the end edge midway between those two points of contact should lie in an imaginary circle having a radius less than three inches. The intermediate point should be located at a distance of approximately three and three sixteenths inches from the axis of symmetry of the circular cylindrical portion of the perimeter of the paint can lid.

In the case of the tool depicted in FIG. 1, for use with a six inch paint can, and having 75° lid-engaging edges 36, the recess 46 is preferably defined by a smoothly curved concave edge, the deepest part of which is approximately 3/16 inch from the closest part of the circle 38 that represents the perimeter of the paint can lid. The shape of the recess 46 can be such that its projection in a plane perpendicular to the surface of a flat part of the tool 10 is a circular arc having a radius less than three inches, and preferably about 1.3 inches. In that case, the depth of the recess will be approximately 0.275 inches from an imaginary straight line connecting the distal ends of edges 32 and 34 of the tool.

FIG. 1 also shows a head 48 of a fastener, on the upper side of the tool near the proximal end, for securing a hammer head for use in tapping a paint can lid to a closed condition. Also shown in FIG. 1 is the end 50 of a fastener which secures a magnet to the bottom side of the tool at a location between parallel edges 32 and 35. The magnet is used to lift the paint can lid from the paint can after it is loosened by prying using the tool.

The proximal end of the tool is preferably formed with two tabs 52 protruding laterally in opposite directions. These tabs can be used in a conventional manner to pry open the lids of smaller paint cans.

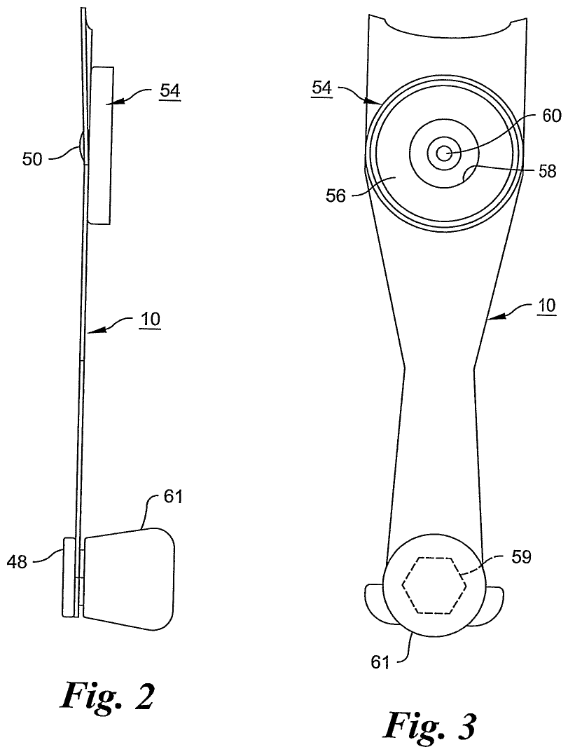

FIGS. 2 and 3, which are, respectively, side and bottom views of the tool, show the magnet 54, which is a permanent magnet, preferably having a circular shape, an annular lid-engaging surface 56, and a central recess 58 to accommodate the head of a fastener 60 which is used to secure the magnet to the distal portion of the tool at a location between the parallel edges 32 and 34. Fastener end 50, shown in FIGS. 1 and 2 is a part of fastener 60. The recessing of the fastener allows the surface 56 of the magnet to engage a paint can lid in face-to-face relationship. The magnet is preferably about two inches in diameter and preferably sufficiently strong to support a 35 pound load.

FIGS. 2 and 3 also show the hammer structure, which comprises a bolt, the head of which is head 48, a hexagonal nut 59 engaged with the bolt, and a cover 61, which is preferably composed of a natural or synthetic rubber or a similar elastomeric material, and frictionally grips the hexagonal nut 59. Nut 59 is recessed within and at least partially covered by, the rubber cover 61, so that only the rubber comes into contact with the paint can lid when the hammer structure is used to tap the lid into a closed condition. By contacting the lid only with the rubber portion of the hammer structure, damage to the lid can be avoided. In a modified embodiment, the rubber cover can be formed so that its end portion encloses the nut 59.

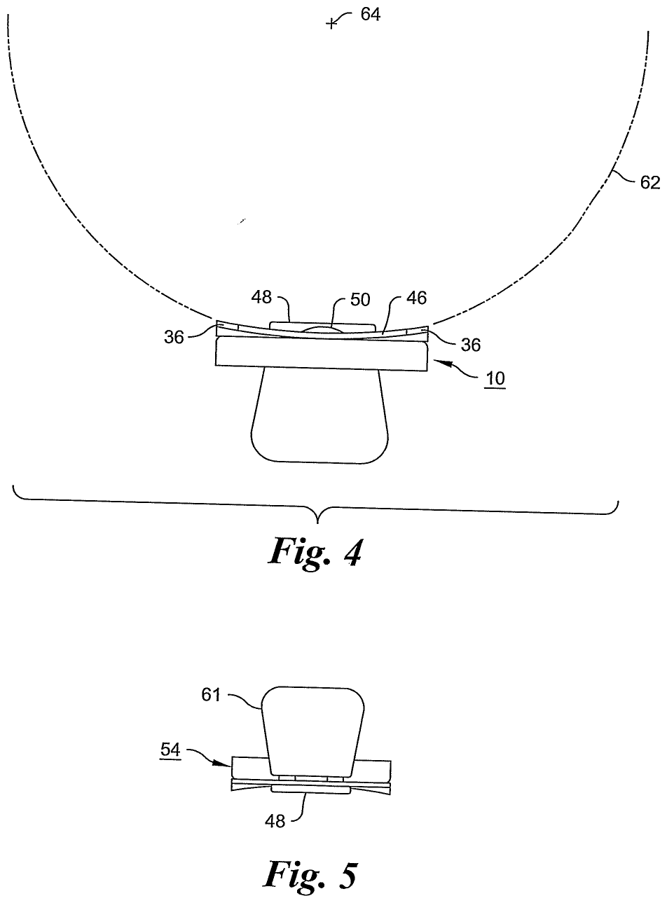

Turning now to FIG. 4, which shows the tool as viewed toward its distal end, it can be seen that the distal end portion of the tool is curved when viewed along the direction of the tool axis. More specifically, the concave edge of recess 46, and preferably also the spaced lid-engaging edges 36, are disposed substantially in the perimeter of a second imaginary circular cylinder, depicted by a broken line 62 having a diameter equal to that of the first imaginary cylinder 38 in FIG. 1, and an axis of symmetry 64 substantially parallel to the handle axis 42 shown in FIG. 1. The curvature of the distal end portion of the tool as depicted in FIG. 4 ensures that, despite the approximately 1.55 inch spacing of the central parts of the lid engaging edges from each other, the distal end of the tool can be received in the annular recess of a paint can, between the rim of the lid and the side wall of the paint can.

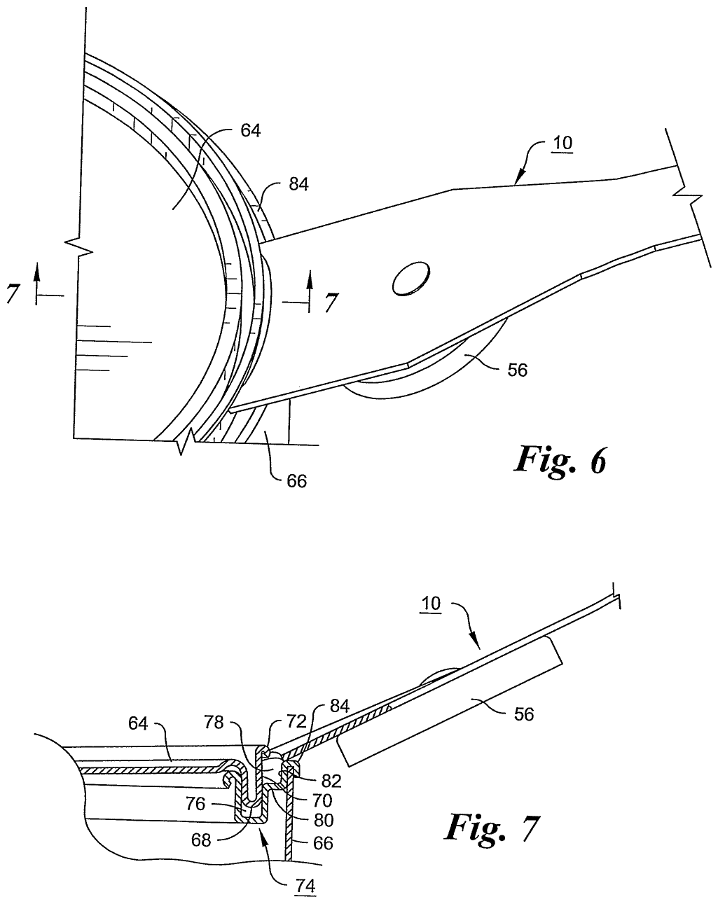

FIGS. 6 and 7 show how the tool is utilized to pry open the lid 64 of a six inch diameter paint can 66.

As shown in FIG. 7, the lid 64 is formed with a downwardly protruding rim portion 68 having a U-shaped cross-section. The rim portion has a cylindrical outer surface 70 and an outwardly protruding upper edge portion 72 for engagement by a prying device. An annular structure 74 has a first annular recess 76 for receiving the downwardly protruding U-shaped rim potion 68 of the lid. A second annular recess 78 is formed by outer surface 70 of the lid, and horizontal portion 80 and vertical portion 82 of the annular structure 74. The upper part of the vertical portion 82 is bent over the top of a cylindrical wall portion of the paint can to form a bead 84. The bead secures the annular structure 74 to the container portion of the paint can, and provides a distortion-resisting fulcrum for engagement by the distal portion of the tool.

To open the paint can, the distal end of the tool is inserted into recess 78. Upon insertion the tool will be either vertical or nearly vertical, and the lid-engaging edges 36 (FIG. 1) at the distal end of the tool will either contact, or closely approach, the horizontal portion 80 of the annular structure. The proximal end of tool is then pushed downward manually causing a portion of the bottom side of the tool adjacent the distal end to contact the bead 84, which then serves as a fulcrum. The lid-engaging edges then exert an upward force on the outwardly protruding upper edge portion 72 of the lid, causing the lid to move upward and out of engagement with the first annular recess 76. Depending on the depth of the concave edge 46 of the recess at the distal end of the tool, the contact between the bottom side of the tool and bead 84 can be either at a central part of the distal end of the tool, or at two spaced parts of the distal end on opposite sides of the center line of the tool.

By applying the tool as illustrated in FIGS. 6 and 7, at several circumferentially spaced locations around the lid of the paint can, e.g., three locations spaced 120° apart from one another the lid can be quickly and easily disengaged from the can. Upon disengagement of the lid, the tool can then be moved to engage the magnet 56 with a central portion of the top of the lid, and the lid can then be lifted and inverted. The tool, with the lid attached to it by the magnet can then be placed on a suitable surface while painting is carried out. The lid can be replaced by lifting and inverting it, using the tool, and the tool can then be disengaged from the lid by twisting while exerting a downward force. The rubber-covered hammer head at the proximal end of the tool can then be used to tap the lid into a fully closed condition.

As will be apparent from the foregoing description, the tool according to the invention facilitates the opening of a paint can lid by making it possible to carry out the prying operations quickly and at a small number of locations. The use of spaced contact areas at the distal end of the tool avoids concentration of force that can lead to lid deformation. The magnet on the tool provides for convenient removal of the lid and minimizes the likelihood of an accidental dropping of the lid and resultant contact of paint adhering to the lid with floors, tarpaulins and other objects.

Modifications can be made to the tool as described herein. For example, the angles and configurations of the spaced lid-engaging edges at the distal end of the tool can be modified without significantly impairing the function of the tool, and the shape of the body of the tool can also be modified. For example, the proximal portion of the tool can be formed with a rounded, generally cylindrical gripping handle. These and many other modifications can be made to the tool as described without departing from the scope of the invention as defined in the following claims.

What is claimed is:

1. A paint can tool comprising an elongated metal plate having opposite proximal and distal ends, said elongated metal plate having:
a handle portion extending along a handle axis in a forward direction, from said proximal end toward said distal end, to an intermediate location along the direction of elongation of the metal plate; and
a paint can lid removal portion at said distal end;
wherein said paint can lid removal portion has opposite side edges and a concave edge facing in said forward direction, said concave edge extending from a location adjacent one of said side edges to a location adjacent the other of said side edges, and said concave edge including two paint can lid-engaging edge portions spaced from each other, respectively located adjacent said opposite side edges, and being tangent to a first imaginary circular cylinder having an axis of symmetry located forward of said concave edge and intersecting said handle axis perpendicularly, the portion of said concave edge between said spaced lid-engaging edge portions thereof being spaced outward from said first imaginary cylinder, and said concave edge is also disposed substantially in the perimeter of a second imaginary circular cylinder having a diameter equal to that of said first imaginary cylinder and an axis of symmetry substantially parallel to said handle axis.

2. The paint can tool according to claim 1, in which each of said paint can lid-engaging edge portions is a substantially straight portion disposed at an angle less than 90° relative to said handle axis.

3. The paint can tool according to claim 1, in which said side edges of the paint can lid removal portion are spaced from each other by at least approximately 1.5 inches at locations adjacent said paint can lid-engaging edge portions.

4. The paint can tool according to claim 1, in which each of said paint can lid-engaging edge portions is a substantially straight portion disposed at an angle less than 90° relative to said handle axis, and in which said side edges of the paint can lid removal portion are spaced from each other by approximately 1.5 inches at locations adjacent said paint can lid-engaging edge portions.

5. The paint can tool according to claim 1, in which each of said paint can lid-engaging edge portions is a substantially straight portion disposed at an angle of approximately 75° relative to said handle axis.

6. The paint can tool according to claim 1, in which said side edges of the paint can lid removal portion are spaced from each other by approximately two inches at locations adjacent said paint can lid-engaging edge portions.

7. The paint can tool according to claim 1, in which each of said paint can lid-engaging edge portions is a substantially straight portion disposed at an angle of approximately 75° relative to said handle axis, and in which said side edges of the paint can lid removal portion are spaced from each other by approximately two inches at locations adjacent said paint can lid-engaging edge portions.

8. The paint can tool according to claim 1, including a permanent magnet secured to said elongated metal plate at a location between the proximal and distal ends thereof.

9. The paint can tool according to claim 1, including a hammer head secured to said elongated plate at a location adjacent said proximal end thereof.

10. The paint can tool according to claim 1, including a hammer head secured to said elongated plate at a location adjacent said proximal end thereof, wherein said hammer head includes a metal stud secured to and extending perpendicularly from the elongated plate.

11. The paint can tool according to claim 1, including a hammer head secured to said elongated plate at a location adjacent said proximal end thereof, wherein said hammer head includes a metal stud secured to and extending perpendicularly from the elongated plate, said metal stud having a first end portion in contact with said plate and a second end portion remote from said plate, and an elastomeric cover at least covering a part of said second end portion.

12. A paint can lid removal tool comprising a metal plate having a surface portion engageable with the upper edge of the wall of a paint can so that said upper edge acts as a fulcrum, said plate also having an end edge formed with first and second lid engaging protrusions for engaging a circular cylindrical portion of the perimeter of a paint can lid when in place on a paint can, said lid engaging portions being spaced from each other, and said end edge being formed with a clearance such that said first and second protrusions can simultaneously engage a circular cylindrical perimeter portion of a paint can lid, said perimeter portion having a radius of approximately three inches, while said surface portion is engaged with the upper edge of the outer wall of the paint can, and exert an upward force against a bead extending outward from said cylindrical perimeter portion of the lid, and a portion of said plate including said edge and said surface portion having a concave surface curvature, with a radius of approximately three inches, for enabling both of the first and second lid-engaging protrusions to enter a space between said bead portion of a paint can lid and the outer wall of a paint can having said lid.

13. The paint can lid removal tool according to claim 12, in which, when said protrusions are in contact with said circular cylindrical perimeter portion of a paint can lid, and said surface portion is engaged with the upper edge of the outer wall of the paint can, the points of contact of the respective protrusions and said perimeter portion that are closest to each other and a intermediate point on said end edge midway between said points of contact lie in an imaginary circle having a radius less than three inches.

14. The paint can lid removal tool according to claim 12, in which, when said protrusions are in contact with said circular cylindrical perimeter portion of a paint can lid, and said surface portion is engaged with the upper edge of the outer wall of the paint can, the points of contact of the respective protrusions and said perimeter portion that are closest to each other and a intermediate point on said end edge midway between said points of contact lie in an imaginary circle having a radius less than three inches, and said intermediate point is located at a distance of approximately three and three sixteenths inches from the axis of symmetry of said circular cylindrical portion of the perimeter of the paint can lid.
